(19) United States
(12) Patent Application Publication
(10) Pub. No.: US 2008/0124058 A1
(43) Pub. Date: May 29, 2008

(54) REPRODUCING APPARATUS, UPDATING CONTROL PROGRAM AND SERVER APPARATUS

(75) Inventor: Mitsuhiro Amou, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 11/858,050

(22) Filed: Sep. 19, 2007

(30) Foreign Application Priority Data
Nov. 29, 2006 (JP) 2006-322287

(51) Int. Cl. H04N 7/26

(52) U.S. Cl. 386/124

(57) ABSTRACT

According to one embodiment, a reproducing apparatus includes: a storage device storing a reproducing program reproducing coded video data or sound data by decoding the data using key data; an acquisition unit acquiring key data for updating to be used to update the key data and a reproducing program for updating to be used to update the reproducing program from an external apparatus; a determination unit determining whether the reproducing program is in need of updating or not; and an updating unit updating the reproducing program to the reproducing program for updating acquired by the acquisition unit in accordance with a determination result of the determination unit when updating the key data to the key data for updating acquired by the acquisition unit.

### CROSS-REFERENCE TO RELATED APPLICATIONS

This application is based upon and claims the benefit of priority from Japanese Patent Application No. 2006-322287, filed Nov. 29, 2006, the entire contents of which are incorporated herein by reference.

### BACKGROUND

1. Field

One embodiment of the invention relates to a reproducing apparatus reproducing video data or sound data, an updating control program of a reproducing program of video data or sound data, and a server apparatus providing a reproducing program.

2. Description of the Related Art

In recent years, along with the spread of communication infrastructures such as an ADSL (Asymmetric Digital Subscriber Line) and an optical communication, a distribution service environment with a full-scale communication for video, music and the like has being developed. In the course thereof, as a terminal to access to a communication network, a PC (Personal Computer) is basically mainly used in households, while, among reproducing apparatuses equipped with a reproducing function of video or sound, those carrying a communication connecting function have been put into practical use.

When reproducing video or sound in the PC or the reproducing apparatus, for example, there is sometimes a case where video data is coded and key data used to decode the video data is provided via the communication network, and the reproducing apparatus decodes the video data using the key data. In this manner, when the video data is coded and a code of the video data is decoded, the decoded video data is possibly copied and distributed without limitation.

Therefore, as a measure against the case of decoding, for example, an updating technology of the key data in an coding scheme defined by AACS (Advanced Access Content System) and the like is conventionally known. In addition to the above, as for the updating technology of the key data, for example, there is a technology disclosed in Japanese Patent Application Publication (KOKAI) No. 6-216897 (Patent document 1). In Patent document 1, there is disclosed a technology in which common key data and algorithm are configured to be changed all together in a data transmitter/receiver apparatus as will be described below. The data transmitter/receiver apparatus is configured to transmit transmission data after coding the data in accordance with a predetermined algorithm and decode the received data based on the common key data in accordance with the predetermined algorithm.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing an internal configuration of a video reproducing apparatus according to a first embodiment of the invention together with a recoding medium and a server apparatus;

FIG. 2 is an exemplary block diagram showing an internal configuration of a server apparatus in the embodiment;

FIG. 3 is an exemplary block diagram showing the video reproducing apparatus and the server apparatus in the embodiment together with data stored in the server apparatus;

FIG. 4 is an exemplary block diagram showing a video reproducing apparatus and a server apparatus according to a second embodiment of the invention together with data stored in the server apparatus;

FIG. 5 is an exemplary block diagram showing a video reproducing apparatus and a server apparatus according to a third embodiment of the invention together with data stored in the server apparatus;

FIG. 6 is an exemplary flowchart showing an operating procedure of an updating control program in the video reproducing apparatus in the first embodiment;

FIG. 7 is an exemplary flowchart showing an operating procedure of an updating control program in the video reproducing apparatus in the second embodiment; and

FIG. 8 is an exemplary flowchart showing an operating procedure of an updating control program in the video reproducing apparatus in the third embodiment.

### DETAILED DESCRIPTION

Various embodiments according to the invention will be described hereinafter with reference to the accompanying drawings. In general, according to one embodiment of the invention, a reproducing apparatus includes: a storage device storing a reproducing program reproducing coded video data or sound data by decoding the data using key data; an acquisition unit acquiring key data for updating to be used to update the key data and a reproducing program for updating to be used to update the reproducing program from an external apparatus; a determination unit determining whether the reproducing program is in need of updating or not; and an updating unit updating the reproducing program to the reproducing program for updating acquired by the acquisition unit in accordance with a determination result of the determination unit when updating the key data to the key data for updating acquired by the acquisition unit.

Further, an updating control computer program product including a computer program causing the computer to realize functions including: an acquisition function acquiring key data for updating to be used to update key data needed to decode coded video data or sound data and a reproducing program for updating to be used to update a reproducing program reproducing the video data or the sound data by decoding the data using the key data from an external apparatus; a determination function determining whether the reproducing program is in need of updating or not; and a updating function updating the reproducing program to the reproducing program for updating acquired by the acquisition function in accordance with a determination result of the determination function when updating the key data to the key data for updating acquired by the acquisition function.

Furthermore, a sever apparatus includes: a storage device storing a reproducing program for updating to be used to update a reproducing program reproducing coded video data or sound data by decoding the data using key data and key data for updating to be used to update the key data; and a provision unit providing the key data for updating and the reproducing program for updating stored in the storage device upon a provision request by an external apparatus.

### First Embodiment

### (Configuration of Video Reproducing Apparatus)

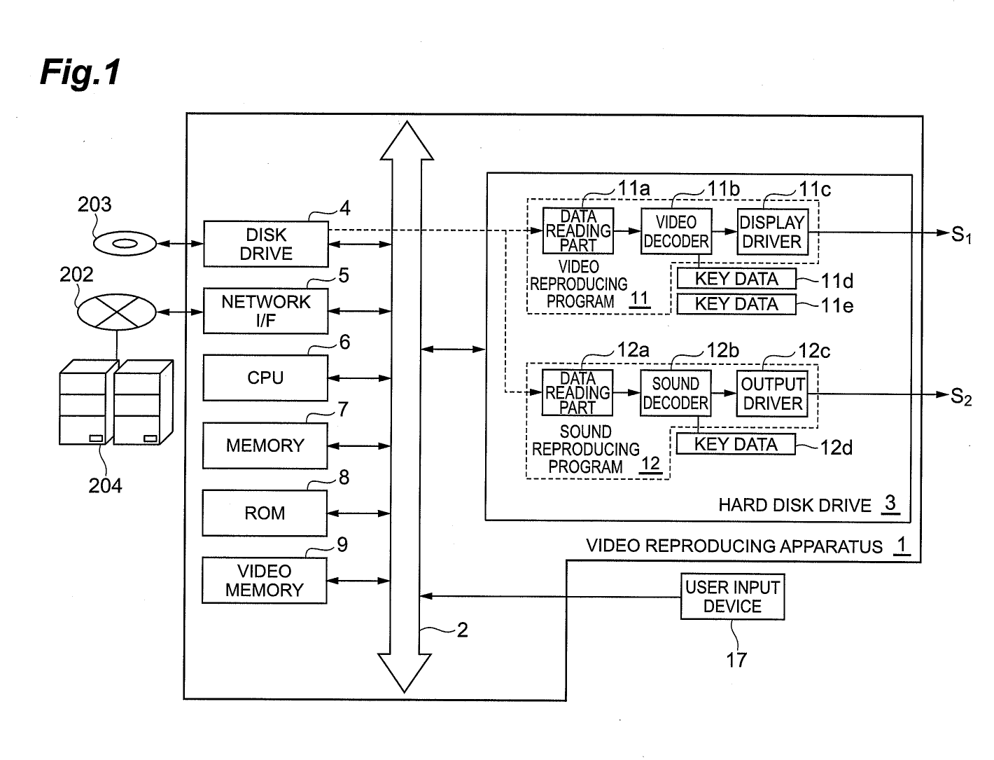

A video reproducing apparatus 1 according to an embodiment of the invention will be described with reference to FIG. 1. FIG. 1 is a block diagram showing an internal configuration of the video reproducing apparatus 1 together with a recording medium 203 and a server apparatus 204. As shown in FIG. 1, the video reproducing apparatus 1 can read later-described video data and sound data of a digital format that are coded in accordance with a predetermined coding scheme and recorded in the recording medium 203 being, for example, an optical disk and the like.

Further, the video reproducing apparatus 1 can acquire a later-described video reproducing program 21 and/or key data 22 from the server apparatus 204 by being connected via internet 202 to the server apparatus 204 being an external apparatus. The video reproducing apparatus 1 is configured to update both already-installed video reproducing program 11 and key data 11d to the video reproducing program 21 and the key data 22 acquired, respectively, so that video data and/or sound data can be reproduced by utilizing the video reproducing program 21 and the key data 22 both after the updating.

The video reproducing apparatus 1 includes a hard disk drive 3, a disk drive 4 and a network interface (I/F) 5, which are all connected to a bus 2. The hard disk drive 3 writes/reads digital data such as the video data into/from a rapidly spinning magnetic disk. Further, the hard disk drive 3 has a function as a storage device storing an already-installed video reproducing program 11, a sound reproducing program 12 and key data 11d, 12d. Furthermore, the hard disk drive 3 stores a later-described updating control program.

The disk drive 4 has a function of reading the digital data such as the video data from the recording medium 203 and outputting it. The network I/F 5 executes communications with the server apparatus 204 via internet 202 and performs operations to receive the video reproducing program 21 and the key data 22 from the server apparatus 204.

Further, the video reproducing apparatus 1 includes a CPU (Central Processing Unit) 6, a memory 7, a ROM 8 and a video memory 9, which are all connected to the bus 2. The CPU 6 is boosted in accordance with a boot program read from the ROM 8 into the memory 7 and controls a system initialization, a system end and the like, letting a system's microcomputer 15 operate. A user input device 17 is composed, for example, of a keyboard, a mouse and the like, and is an operating input device for a user to input desired data as operating input data.

Further, the CPU 6 executes the video reproducing program 11 and the sound reproducing program 12 to decode the digital data read out from the recording medium 203 or the hard disk drive 3, performs a predetermined image processing to a video signal outputted therefrom, and outputs a video output signal S1. Furthermore, the CPU 6 decodes sound data using the digital data, performs a predetermined sound processing to a sound signal outputted therefrom, and outputs an audio output signal S2. In the memory 7, data and a program used when the CPU 6 operates are stored. In the ROM 8, a program or the like that the CPU 6 executes, such as the boot program, is stored. Into the video memory 9, the decoded (demodulated) video data are written sequentially.

Note that the video data and the sound data that the video reproducing program 11 and the sound reproducing program 12 read out from the recording medium 203 or the like to process are coded in accordance with a predetermined coding scheme, respectively.

In the embodiment, the video reproducing program 11 includes a data reading part (data read module) 11a, a video decoder (video decode module) 11b and a display driver (display control module) 11c, as shown in FIG. 1. The data reading part 11a realizes a function of reading out the digital data supplied from the disk drive 4. The video decoder 11b performs a decoding process decoding the coded video data based on the key data 11d. The display driver 11c generates a video signal from the video data decoded by the video decoder 11b.

Note that a prohibited key data lie is installed into the video reproducing apparatus 1 in addition to the key data 11d. The prohibited key data 11e is the key data which is prohibited for use in the video decoder 11b when decoding the video data. When the video decoder 11b uses the prohibited key data 11e when decoding the coded video data, the decoding by the video decoder 11b is defined as an error.

In the embodiment, the sound reproducing program 12 includes a data reading part (data read module) 12a, a sound decoder (sound decode module) 12b, and an output driver (output control module) 12c, as shown in FIG. 1. The data reading part (data read module) 12a realizes a function of reading out the digital data supplied from the disk drive 4. The sound decoder 12b performs a decoding process decoding the coded sound data based on the key data 12d. The output driver 12c generates a sound signal from the sound data decoded by the sound decoder 12b.

### (Configuration of Server Device)

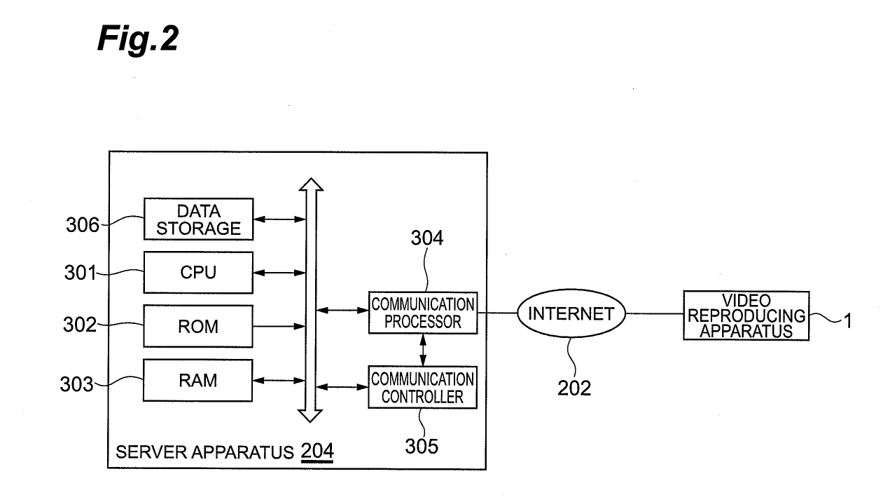

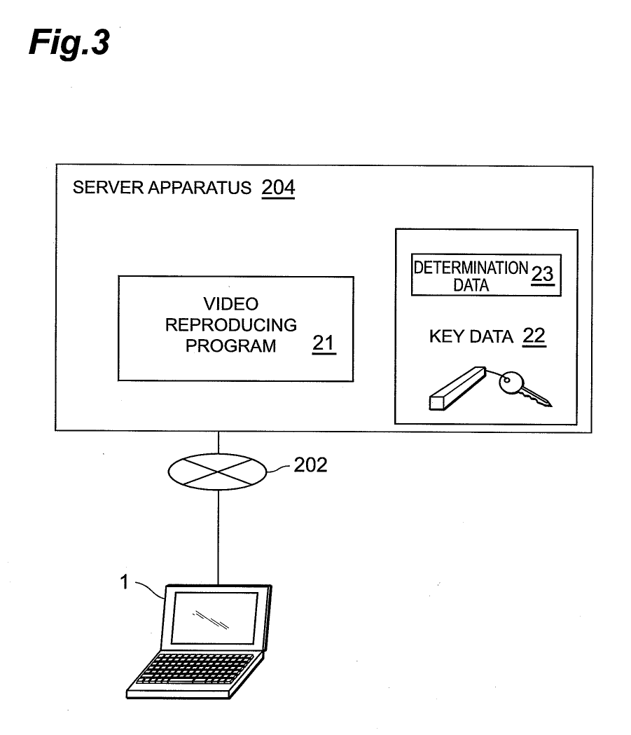

Subsequently, the description will be given of the configuration of the server apparatus 204 with reference to FIG. 2 and FIG. 3. As shown in FIG. 2, the server apparatus 204 includes a CPU (Central Processing Unit) 301, a ROM (Read Only Memory) 302, a RAM (Random Access Memory) 303, a communication processor 304, a communication controller 305 and a data storage device 306. The CPU 301 operates by reading/writing data with respect to the RAM 303 in accordance with the program stored in the ROM 302, while the communication controller 305 lets the communication processor 304 operate in accordance with the instruction by the CPU 301, and thereby the server apparatus 204 performs data communication with the video reproducing apparatus 1.

In the embodiment, the server apparatus 204 stores the video reproducing program 21 and the key data 22 shown in FIG. 3 in the data storage device 306 thereof, in which the data storage device 306 has a function as a storage device. The video reproducing program 21 is a video reproducing program for updating to be used to update the above-described video reproducing program 11. The video reproducing program 21 includes the same data reading part, video decoder and display driver as in the video reproducing program 11.

The key data 22 is a key data for updating to be used when the video decoder in the video reproducing program 21 decodes the video data to update the key data 11d. Further, the key data 22 has a determination data 23 embedded in. The determination data 23 indicates whether the video reproducing program 11 installed into the video reproducing apparatus 1 is in need of the updating or not.

Since the key data 22 has the determination data 23 embedded therein, the video reproducing apparatus 1 can acquire the determination data 23 together by receiving and acquiring the key data 22 from the server apparatus 204. Note that the determination data 23 may be provided in an accompanying manner the key data 22, and in that case, also, the video reproducing apparatus 1 can receive the determination data 23 by receiving the key data 22.

### (Operations of Video Reproducing Apparatus)

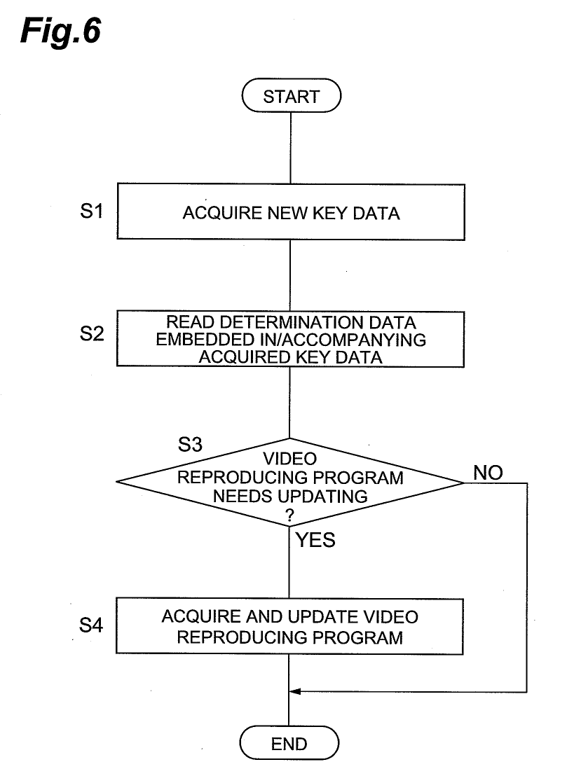

Subsequently, the description will be given of an operation procedure when the video reproducing apparatus 1 updates the video reproducing program 11 with reference to the flowchart shown in FIG. 6. The video reproducing apparatus 1 updates the video reproducing program 11 by executing the updating control program. The updating control program is executed by the CPU 6. Note that FIG. 6 is a flowchart showing an updating procedure of the video reproducing program 11 performed in accordance with the updating control program.

The CPU 6 executes the updating control program when an updating request for the key data is made. Here, as a case where the updating request for the key data is made, for example, a case where the term of validity of the installed key data 11d is expired, a case where the video decoder 11b reads the prohibited key data 11e prohibited for use in decoding the video data, or the like is applicable.

In that case, the CPU 6 proceeds to block 1 to let the network I/F 5 operate as an acquisition unit to receive and acquire the key data 22 from the server apparatus 204 and replaces the already-installed key data 11d with the received key data 22 to thereby update the key data 11d.

Subsequently, the CPU 6 proceeds to block 2 and reads the determination data 23 embedded in or accompanying the acquired key data 22. Subsequently, further, the CPU 6 proceeds to block 3 and operates as a determination unit to determine whether the determination data 23 that is read indicates a need of updating, in which the video reproducing program 11 is needed to be updated, or not. Here, when the determination data 23 is determined to indicate the need of updating, then block 4 is executed, and when not, the updating control program ends without executing block 4.

The CPU 6 performs an operation as an acquisition unit and an updating unit when executing block 4. In that case, the CPU 6 acquires the video reproducing program 21 by letting the network I/F 5 operate, and makes a replacement with the acquired video reproducing program 21 to thereby update the video reproducing program 11.

By doing as above, when the key data 11d is in need of updating, the updating can be performed not only to the already-installed key data 11d, but also to the video reproducing program 11. Therefore, even when the coded video data is decoded and the video reproducing program 11 has a problem of allowing for the decoding of the video data, the video reproducing program 11 is replaced with the video reproducing program 21, so that the possibility that the video data may be decoded again is reduced. Further, the updating is performed not only to the video decoder realizing the decoding function, but also to the video reproducing program 11 realizing a variety of functions in addition to the decoding function, so that the video data can be prevented from decoding surely.

### Second Embodiment

In a second embodiment, a server apparatus 205 is connected to the video reproducing apparatus 1 in place of the server apparatus 204. Further, corresponding to the server apparatus 205 connected to the video reproducing apparatus 1, the updating control program is partly different from the updating control program in the first embodiment, whereas the both have the same configuration in the other respect.

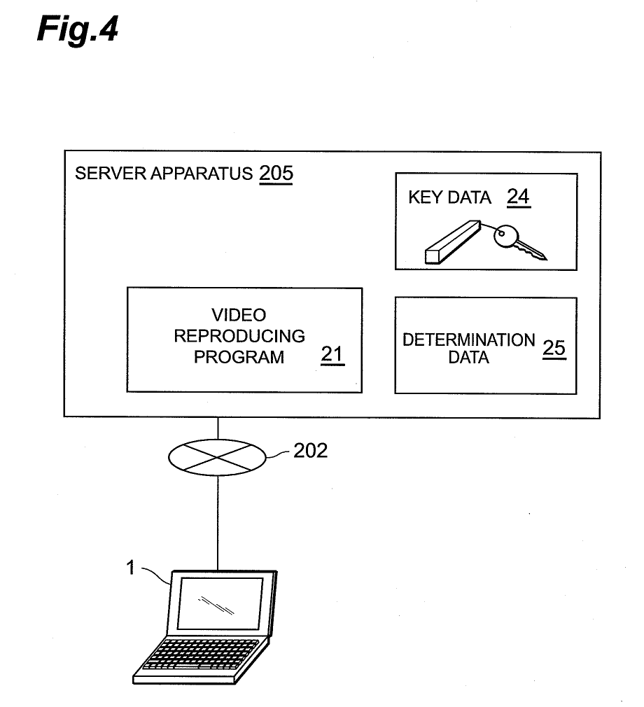

As shown in FIG. 4, compared with the server apparatus 204, the server apparatus 205 is different in that it stores key data 24 in place of the key data 22 in the data storage device 306 and that the data storage device 306 also stores determination data 25, while the both have the same configuration in the other respect.

Compared with the key data 22, the key data 24 is different in that the determination data 23 is not embedded therein, while the both are the same in the other respect. Compared with the determination data 23, the determination data 25 is different in that it is stored separately from the key data 24 as data of an independent file without being embedded in the key data 22, while the both are the same in the other respect.

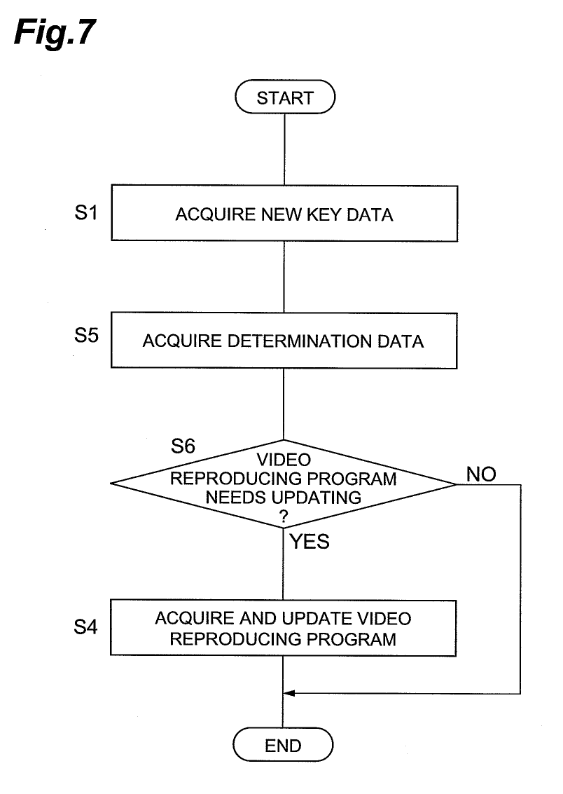

When the video reproducing apparatus 1 is connected to the server apparatus 205 in place of the server apparatus 204, the video reproducing apparatus 1 operates along with the flowchart shown in FIG. 7 to update the video reproducing program 11.

In that case, the CPU 6 executes block 1 in the same manner as in the first embodiment to acquire the key data 24, and subsequently, executes block 5 in stead of block 2. When block 5 is executed, the CPU 6 lets the network I/F 5 operate to acquire the determination data 25 from the server apparatus 205. Subsequently, the CPU 6 proceeds to block 6 and operates as a determination unit to determine whether the determination data 25 is in need of updating or not. Here, when the determination data 25 is determined to indicate the need of updating, then block 4 is executed in the same manner as in the first embodiment, and when not, the updating control program ends without executing block 4.

As described above, also in the video reproducing apparatus 1 in the embodiment, when the key data 11d is in need of updating, the updating is performed not only to the already-installed key data 11d, but also to the video reproducing program 11. Accordingly, also in the video reproducing apparatus 1 in the embodiment, the possibility that the vide data may be decoded again is reduced, so that the video data can be prevented from decoding surely.

### Third Embodiment

In a third embodiment, a server apparatus 206 is connected to the video reproducing apparatus 1 in place of the server apparatus 204. Further, corresponding to the server apparatus 206 connected to the video reproducing apparatus 1, the updating control program is partly different from the updating control program in the first embodiment, while the both have the same configuration in the other respect.

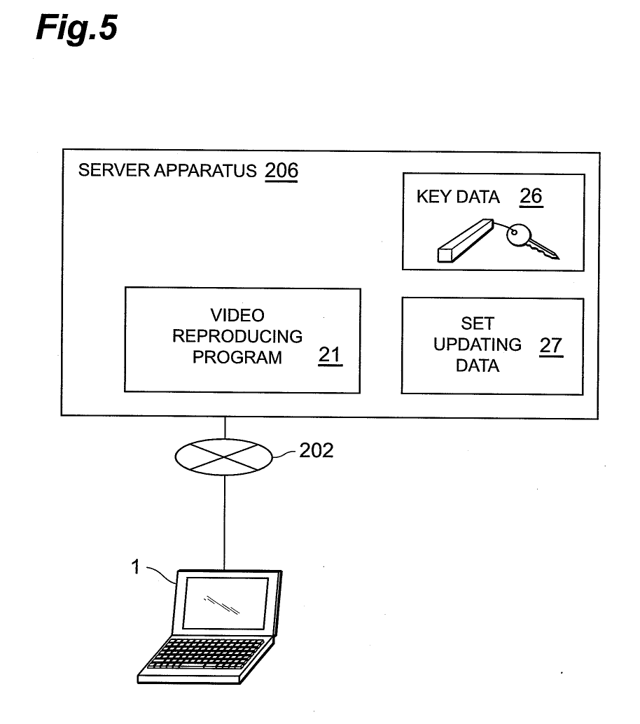

Compared with the server apparatus 204, as shown in FIG. 5, the server apparatus 206 is different in that it stores key data 26 in place of the key data 22 in the data storage device 306 and that the data storage device 306 also stores set updating data 27, while the both have the same configuration in the other respect.

Compared with the key data 22, the key data 26 is different in that the determination data 23 is not embedded therein, while the both are the same in the other respect. The set updating data 27 is data indicating the updating of the video reproducing program 11 together with the key data 11d.

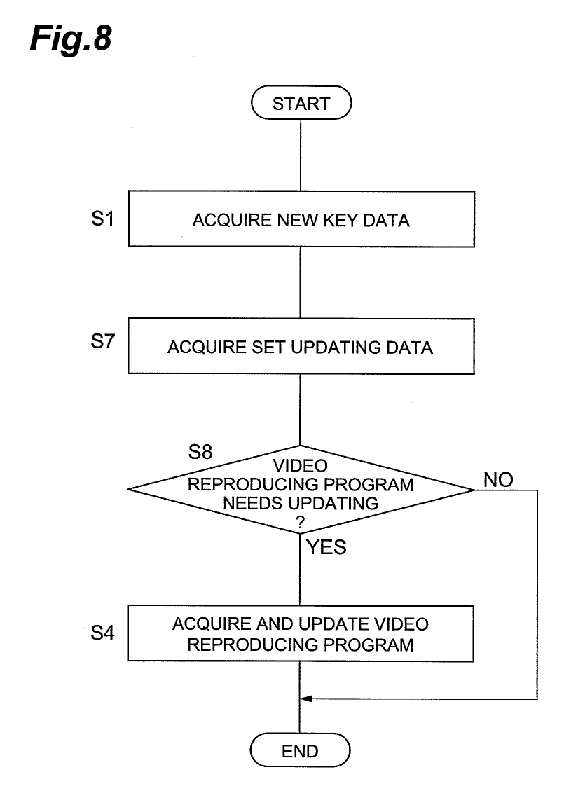

When the video reproducing apparatus 1 is connected to the server apparatus 206 in place of the server apparatus 204, the video reproducing apparatus 1 operates along with the flowchart shown in FIG. 8 to update the video reproducing program 11.

In that case, the CPU 6 executes block 1 in the same manner as in the first embodiment to thereby acquire the key data 26. Subsequently, the CPU 6 executes block 7 in stead of block 2. When block 7 is executed, then the CPU 6 lets the network I/F 5 operate to receive the set updating data 27 from the server apparatus 206 to update. Also, the CPU 6 proceeds to block 8 and operates as a determination unit to determine whether the video reproducing program 11 is in need of updating or not based on the acquired set updating data 27. Here, when the set updating data 27 is determined to indicate the need of updating, then block 4 is executed in the same manner as in the first embodiment, and when not, the updating control program ends without executing block 4.

As described above, also in the video reproducing apparatus 1 in the embodiment, when the key data 11d is in need of updating, the updating is performed not only to the already-installed key data 11d, but also to the video reproducing program 11. Accordingly, also in the video reproducing apparatus 1 in the embodiment, the possibility that the vide data may be decoded again is reduced, so that the video data can be prevented from decoding surely.

In the above-described respective embodiments, the case where the video reproducing apparatus 1 receives the key data from the server apparatus is described by way of example, whereas the key data may be acquired from an external apparatus different from the server apparatus. Further, the case where the video reproducing program is updated is described by way of example, whereas the invention is also applicable to the updating of the sound reproducing program.

The above description is intended to describe the embodiments of the invention and not intended to limit the apparatus and the method of the invention, allowing a variety of modification examples to be embodied with ease. Further, the apparatus or the method configured by appropriately combining the components, the functions, the characteristics or the methodological steps in the respective embodiments is also within the scope of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A reproducing apparatus comprising:
a storage device configured to store a first reproducing program for reproducing coded video data and sound data by decoding the data using first key data;
an acquisition unit configured to acquire, from an external apparatus, second key data to update the first key data, and a second reproducing program to update the first reproducing program;
a determination unit configured to determine whether the first reproducing program is in need of updating or not; and
an updating unit configured to update the first reproducing program based upon the second reproducing program in accordance with a determination result of said determination unit when the first key data is updated based upon the second key data.

2. The reproducing apparatus according to claim 1, wherein said determination unit is configured to determine whether the first reproducing program is in need of updating or not based on determination data embedded in or accompanying the second key data.

3. The reproducing apparatus according to claim 1, wherein said acquisition unit is configured to acquire, from an external apparatus, determination data which can then be used to determine whether the first reproducing program is in need of updating or not.

4. An computer program product comprising a computer program, the program causing a computer to perform a method comprising:
acquiring second key data to be used to update first key data needed to decode coded video data or sound data; and
;
determining, according to a determination method, whether a first reproducing program for reproducing the video data or the sound data by decoding the data using the first or second key data is in need of updating or not; and
updating the first reproducing program based upon a second reproducing program in accordance with a determination result of said determination method when the first key data is updated based upon the second key data.

5. The updating control computer program product according to claim 4, wherein said determination function is configured to determine whether the first reproducing program is in need of updating or not based on determination data embedded in or accompanying the second key data.

6. The updating control computer program product according to claim 4, further comprising acquiring determination data to determine whether the first reproducing program is in need of updating or not from an external apparatus in addition to the second key data, and wherein said determination function is configured to determine whether the first reproducing program is in need of updating or not based on the determination data.

7. A server apparatus comprising:
a storage device storing a second reproducing program for updating a first reproducing program for reproducing coded video data and sound data by decoding the data using first key data, and storing second key data for updating the first key data; and
a provision unit configured to provide the second key data and the second reproducing program upon a provision request by an external apparatus.

8. The server apparatus according to claim 7, wherein the storage device stores
determination data, embedded in or accompanying the second key data, to determine whether the first reproducing program is in need of updating or not.

9. The server apparatus according to claim 7, wherein said storage device stores determination data to determine whether the first reproducing program is in need of updating or not separately from the second key data, and wherein said provision unit is configured to provide the determination data upon a provision request from an external apparatus in addition to the second key data and the second reproducing program.
